(19) United States
(12) Patent Application Publication
(10) Pub. No.: US 2026/0361381 A1
(43) Pub. Date: Nov. 12, 2026

(54) USAGE OF ONGOING INITIAL SECTOR SWEEPS TO ADJUST ANALOG BEAMFORMING

(71) Applicant: Cisco Technology, Inc., San Jose, CA (US)

(72) Inventors: Matthew Aaron Silverman, Shaker Heights, OH (US); Ardalan Alizadeh, Milpitas, CA (US); Peiman Amini, Fremont, CA (US)

(21) Appl. No.: 19/671,968

(22) Filed: May 8, 2026

Related U.S. Application Data
(60) Provisional application No. 63/803,293, filed on May 9, 2025.

(51) Int. Cl. H04B 7/06; H01Q 5/20; H04B 7/0426

(52) U.S. Cl. CPC H04B 7/06952; H01Q 5/20; H04B 7/043

(57) ABSTRACT

Usage of ongoing initial sector sweeps to adjust analog beamforming may be provided. A first computing device may schedule, over a first frequency spectrum connection with a second computing device, a first service period in which a first plurality of data units may be transmitted. Next, the first computing device may transmit, over a second frequency spectrum connection during the first service period, the first plurality of data units in a first plurality of signals respectively. Each of the first plurality of signals may be beamformed to a first plurality of different sectors respectively within a first sweep radius. Then the first computing device may receive, from the second computing device, a first feedback associated with at least one of the first plurality of signals.

### RELATED APPLICATION

Under provisions of 35 U.S.C. § 119(e), Applicant claims the benefit of U.S. Provisional Application No. 63/803,293, filed May 9, 2025, which is incorporated herein by reference.

### TECHNICAL FIELD

The present disclosure relates generally to providing usage of ongoing initial sector sweeps to adjust analog beamforming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing usage of ongoing initial sector sweeps to adjust analog beamforming;

FIG. 2 is a flow chart of a method for providing usage of ongoing initial sector sweeps to adjust analog beamforming; and

FIG. 3 is a block diagram of a computing device.

### DETAILED DESCRIPTION

### Overview

Usage of ongoing initial sector sweeps to adjust analog beamforming may be provided. A first computing device may schedule, over a first frequency spectrum connection with a second computing device, a first service period in which a first plurality of data units may be transmitted. Next, the first computing device may transmit, over a second frequency spectrum connection during the first service period, the first plurality of data units in a first plurality of signals respectively. Each of the first plurality of signals may be beamformed to a first plurality of different sectors respectively within a first sweep radius. Then the first computing device may receive, from the second computing device, a first feedback associated with at least one of the first plurality of signals.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11ad/ay standard defines Sector Level Sweep (SLS) in order to allow for basic association of Millimeter Wave (mmW) band client devices. SLS may rapidly send multiple beacons beamformed to different sectors. Without this sweep, most association may fail because the range for the mmW band may be too poor without beamforming gain.

While SLS may still be used for basic reachability in the mmW band, once a sub 7 GHz AP/client pair has decided to try to connect at the mmW band, it may no longer be needed for sweeping all sectors to connect random, unknown clients. Also, Integrated Millimeter Wave (ImmW) may not exist as a mmW only technology, so it may only be needed after sub 7 GHz association has occurred and may be triggered/catered to the associated client devices that are also trying to connect in the mmW band (e.g., 60 GHz). Accordingly, embodiments of the disclosure may use SLS to do analog beamforming updating instead of basic association for example.

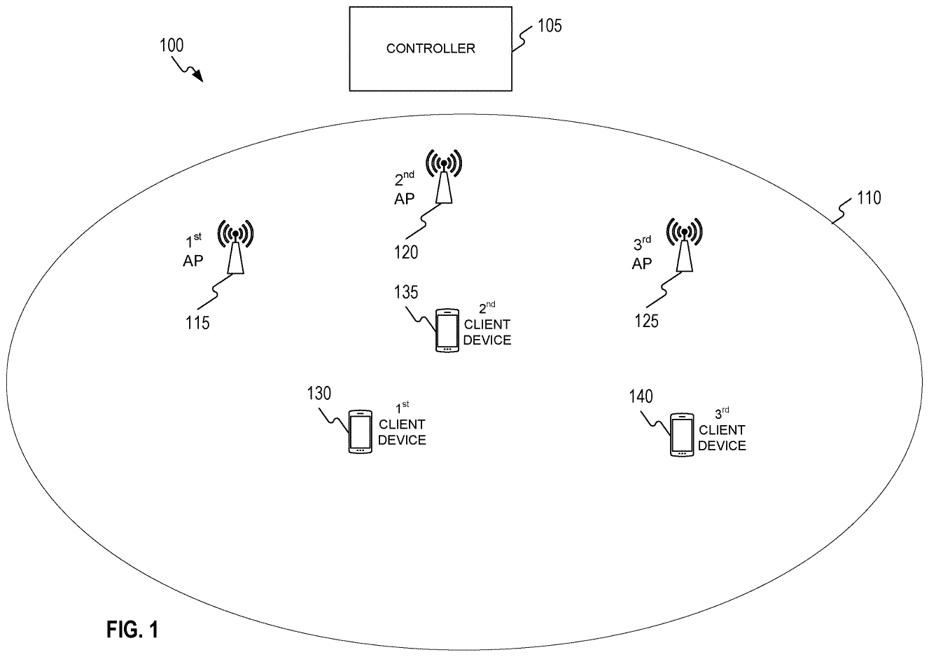

FIG. 1 shows an operating environment 100 for providing usage of ongoing initial sector sweeps to adjust analog beamforming. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

The 2.4 GHz band, the 5 GHz band, and the 6 GHz band may be referred together as the sub 7 GHz band. In addition to the sub 7 GHz band, embodiments of the disclosure may operate in the mmW band. The mmW band may refer to an extremely high-frequency spectrum band (e.g., between 30 GHz and 300 GHz, often 60 GHz) delivering multi-gigabit, low-latency, short-range, line-of-sight connectivity. The mmW band may enable ultra-fast, high-capacity wireless networks, acting, for example, for massive data in crowded places and for Fixed Wireless Access (FWA).

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide usage of ongoing initial sector sweeps to adjust analog beamforming.

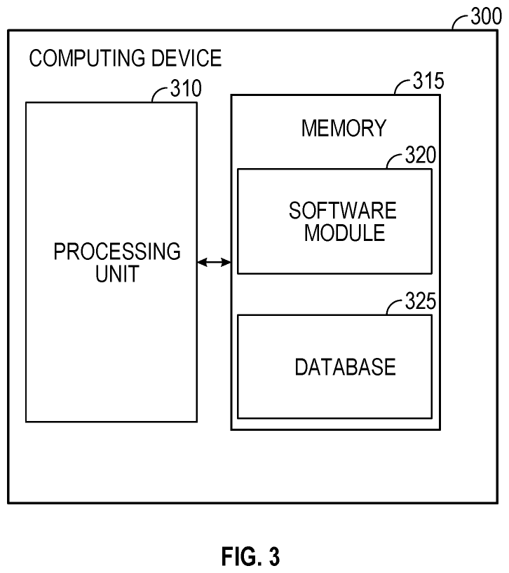

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

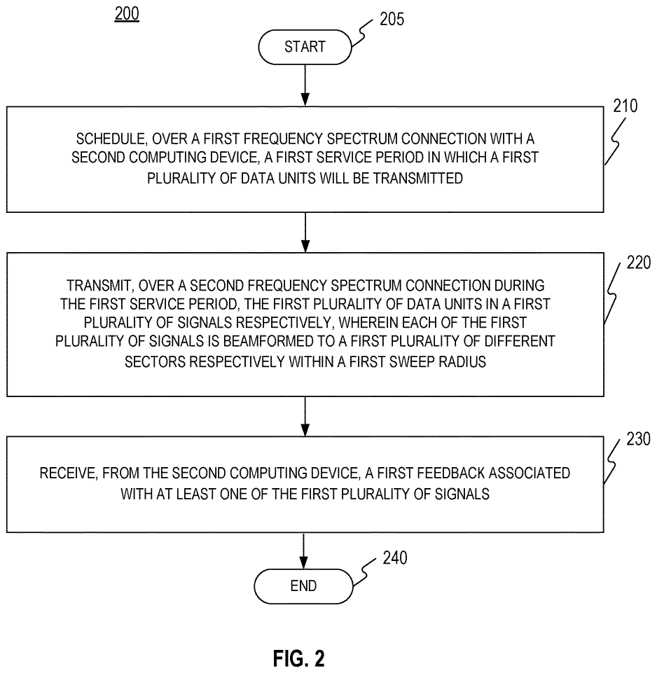

FIG. 2 is a flow chart setting forth the general stages involved in a method 200 consistent with embodiments of the disclosure for providing usage of ongoing initial sector sweeps to adjust analog beamforming. Method 200 may be implemented using computing device 300 as described in more detail below with respect to FIG. 3 that may be embodied by first AP 115 or first client device 130. Ways to implement the stages of method 200 will be described in greater detail below.

Method 200 may begin at starting block 205 and proceed to stage 210 where first AP 115 may schedule, over a first frequency spectrum connection with first client device 130, a first service period in which a first plurality of data units may be transmitted. For example, the first frequency spectrum connection may comprise a sub 7 GHz frequency spectrum connection that has previously been established between first AP 115 and first client device 130. The first plurality of data units may comprise, but are not limited to, a first plurality of Physical Layer Convergence Procedure (PLCP) Protocol Data Units (PPDUs). The first service period may be communicated to first client device 130 so that first client device 130 may know when to expect the first plurality of data units.

From stage 210, where first AP 115 schedules, over the first frequency spectrum connection with first client device 130, the first service period in which the first plurality of data units will be transmitted, method 200 may advance to stage 220 where first AP 115 may transmit, over a second frequency spectrum connection during the first service period, the first plurality of data units in a first plurality of signals respectively. Each of the first plurality of signals may be beamformed to a first plurality of different sectors respectively within a first sweep radius. For example, the second frequency spectrum may comprise a mmW band connection. The mmW band connection may comprise, but is not limited to, a 60 GHz frequency spectrum connection. The first sweep radius may comprise, but is not limited to, 360 degrees around first AP 115. The first plurality of different sectors may comprise, but are not limited to, 32 sectors evenly distributed in the 360 degree first sweep radius for example.

With conventional systems, when a client device is attempting to associate to a mmW radio, the client device may have no idea if it may associate because the range of the mmW radio may be so much less than a sub 7 GHz radio. To connect, most of the time the client device has to find the best beamforming on the AP Transmit (Tx) and client device Receive (Rx) side. Typically, the AP Tx side is discovered first. With conventional systems, the mmW radio may be standalone, and the client device may have to constantly send beacons beamformed to different sectors for unassociated client devices to have a chance to hear one of the sectors. With embodiments of the disclosure, the sub 7 GHz radio may provide the initial association, that may be used to coordinated the mmW connection.

Once first AP 115 transmits, over the second frequency spectrum connection during the first service period, the first plurality of data units in the first plurality of signals respectively in stage 220, method 200 may continue to stage 230 where first AP 115 may receive, from first client device 130, a first feedback associated with at least one of the first plurality of signals. For example, the first feedback may be received over the first frequency spectrum connection or the second frequency spectrum connection. The first feedback may indicate that the at least one of the first plurality of signals has a strongest Received Signal Strength Indicator (RSSI) of all of the first plurality of signals that were received by the second computing device. According, first AP 115 may use the sector that produced the strongest RSSI to communicate with first client device 130 over the mmW connection. Once first AP 115 receives, from first client device 130, the first feedback associated with at least one of the first plurality of signals in stage 230, method 200 may then end at stage 240.

In addition to the initial aforementioned association/beam acquisition, additional sector sweeps may be used in a reoccurring manner to update/adjust beams of associated/previously fully beam-trained client devices. Accordingly, first AP 115 may transmit over the second frequency spectrum connection, a second plurality of data units in a second plurality of signals respectively. Each of the second plurality of signals may be beamformed to a second plurality of different sectors respectively within a second sweep radius that is less that the first sweep radius and wherein the second sweep radius includes the second computing device (e.g., first client device 130).

The second sweep radius may comprise, but is not limited to, 90 degrees around first AP 115. The second plurality of different sectors may comprise, but are not limited to, 32 sectors evenly distributed in the 90 degree second sweep radius for example. Because the location of first client device may be roughly known by first AP 115, the smaller second sweep radius may be selected to include first client device 130. In this way, embodiments of the disclosure may fine tune the second frequency spectrum connection between first AP 115 and first client device 130 or to account for any spatial drift of first client device 130. Similar subsequent sweeps may be performed to fine tune and account for further spatial drift. While the aforementioned process is described as first AP 115 performing the process with first client device 130, the aforementioned process may be performed by first client device 130 with first AP 115.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing usage of ongoing initial sector sweeps to adjust analog beamforming as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
scheduling, by a first computing device over a first frequency spectrum connection with a second computing device, a first service period in which a first plurality of data units will be transmitted;
transmitting, by the first computing device over a second frequency spectrum connection during the first service period, the first plurality of data units in a first plurality of signals respectively, wherein each of the first plurality of signals is beamformed to a first plurality of different sectors respectively within a first sweep radius; and
receiving, from the second computing device, a first feedback associated with at least one of the first plurality of signals.

2. The method of claim 1, further comprising establishing, by the first computing device, the first frequency spectrum connection with the second computing device.

3. The method of claim 1, wherein the first frequency spectrum connection comprises a sub 7 GHz frequency spectrum connection.

4. The method of claim 1, wherein the second frequency spectrum connection comprises a Millimeter Wave (mmW) band connection.

5. The method of claim 1, wherein the second frequency spectrum connection comprises a 60 GHz frequency spectrum connection.

6. The method of claim 1, wherein receiving the first feedback comprises receiving the first feedback over the first frequency spectrum connection.

7. The method of claim 1, wherein receiving the first feedback comprises receiving the first feedback over the second frequency spectrum connection.

8. The method of claim 1, wherein the first computing device comprise an Access Point (AP).

9. The method of claim 1, wherein the second computing device comprises a client device.

10. The method of claim 1, wherein the first plurality of data units comprise a first plurality of Physical Layer Convergence Procedure (PLCP) Protocol Data Units (PPDUs).

11. The method of claim 1, wherein receiving the first feedback comprises receiving the first feedback indicating that the at least one of the first plurality of signals has a strongest Received Signal Strength Indicator (RSSI) of all of the first plurality of signals that were received by the second computing device.

12. The method of claim 1, further comprising transmitting, by the first computing device over the second frequency spectrum connection, a second plurality of data units in a second plurality of signals respectively, wherein each of the second plurality of signals is beamformed to a second plurality of different sectors respectively within a second sweep radius that is less that the first sweep radius and wherein the second sweep radius includes the second computing device.

13. The method of claim 12, further comprising receiving, from the second computing device, a second feedback associated with at least one of the second plurality of signals.

14. A system comprising:
a memory storage; and
a processing unit disposed in a first computing device and coupled to the memory storage, wherein the processing unit is operative to:
schedule, over a first frequency spectrum connection with a second computing device, a first service period in which a first plurality of data units will be transmitted;
transmit, over a second frequency spectrum connection during the first service period, the first plurality of data units in a first plurality of signals respectively, wherein each of the first plurality of signals is beamformed to a first plurality of different sectors respectively within a first sweep radius; and
receive, from the second computing device, a first feedback associated with at least one of the first plurality of signals.

15. The system of claim 14, wherein the first frequency spectrum connection comprises a sub 7 GHz frequency spectrum connection.

16. The system of claim 14, wherein the second frequency spectrum connection comprises a Millimeter Wave (mmW) band connection.

17. A non-transitory computer-readable medium that stores a set of instructions which when executed perform a method executed by the set of instructions comprising:
scheduling, by a first computing device over a first frequency spectrum connection with a second computing device, a first service period in which a first plurality of data units will be transmitted;
transmitting, by the first computing device over a second frequency spectrum connection during the first service period, the first plurality of data units in a first plurality of signals respectively, wherein each of the first plurality of signals is beamformed to a first plurality of different sectors respectively within a first sweep radius; and
receiving, from the second computing device, a first feedback associated with at least one of the first plurality of signals.

18. The non-transitory computer-readable medium of claim 17, wherein receiving the first feedback comprises receiving the first feedback indicating that the at least one of the first plurality of signals has a strongest Received Signal Strength Indicator (RSSI) of all of the first plurality of signals that were received by the second computing device.

19. The non-transitory computer-readable medium of claim 17, further comprising transmitting, by the first computing device over the second frequency spectrum connection, a second plurality of data units in a second plurality of signals respectively, wherein each of the second plurality of signals is beamformed to a second plurality of different sectors respectively within a second sweep radius that is less that the first sweep radius and wherein the second sweep radius includes the second computing device.

20. The non-transitory computer-readable medium of claim 19, further comprising receiving, from the second computing device, a second feedback associated with at least one of the second plurality of signals.
